(19) United States
(12) Patent Application Publication
(10) Pub. No.: US 2026/0315190 A1
(43) Pub. Date: Oct. 15, 2026

(54) ORTHODONTIC ENVELOPE MULTIPLE ALIGNMENT DEVICE

(71) Applicants: Tufy Lemos Filho, SÃO JOSÉ DO RIO PRETO (BR); Maria Do Rozario De Azevedo Mendes Lemos, SÃO JOSÉ DO RIO PRETO (BR); Victor Mendes Lemos, SÃO JOSÉ DO RIO PRE¿¿ (BR); Thais Mendes Lemos Tunes, SÃO JOSÉ DO RIO PRET¿ (BR)

(72) Inventors: Tufy Lemos Filho, SÃO JOSÉ DO RIO PRETO (BR); Maria Do Rozario De Azevedo Mendes Lemos, SÃO JOSÉ DO RIO PRETO (BR); Victor Mendes Lemos, SÃO JOSÉ DO RIO PRE¿¿ (BR); Thais Mendes Lemos Tunes, SÃO JOSÉ DO RIO PRET¿ (BR)

(21) Appl. No.: 19/146,029

(22) PCT Filed: Jan. 11, 2024
(86) PCT No.: PCT/BR2024/050011

§ 371 Date: Jul. 7, 2025

(30) Foreign Application Priority Data
Jan. 13, 2023 (BR) 1020230007325

(51) Int. Cl. A61C 7/12; A61C 7/08

(52) U.S. Cl. CPC A61C 7/12; A61C 7/08

(57) ABSTRACT

The present invention patent relates to an orthodontic envelope multiple alignment device, pertaining to the technical field of accessories for orthodontic treatment, and more particularly to a multiple alignment device made up of a dental arch (A) that forms a single body (1), having two or three layers (11, 12 and 13) containing between them various accessories (AC) such as: an archwire or archwires and/or brackets and/or buccal tubes and/or other accessories. The layer (11) is formed by individual crowns WO (111) for receiving the accessories (AC), and each of the layers (12 and 13) is formed as a single piece. The layers are formed by a sheet (F) that receives, positions, fits, protects and envelops the dental arch (A) and the accessories (AC), the sheets (plates) being produced from transparent materials such as PET, PET-G, polyurethane, acetate or equivalent materials, wherein each of the sheets (plates) is produced individually using a vacuum forming and/or thermoforming manufacturing process and/or using direct 3D printing manufacturing process, or as a coating applied by spraying or with a brush, or any other available process. Optionally, the layers (11, 12 and 13) can be produced using a liquid material (ML) or a paste. Also, optionally, the layer (11) is provided with a crown (111) for receiving the accessories (AC), wherein the crown is transparent or opaque.

The present invention patent relates to an Orthodontic Envelope Multiple Alignment device, pertaining to the technical field of accessories for orthodontic treatment, and more particularly to a Multiple Alignment Envelope device consisting of a single body, formed in layers, between which are enclosed different accessories such as: archwire or archwires and/or brackets and/or buccal tubes and/or other various accessories when necessary and/or other apparatus and devices indicated for orthodontic treatment located on the lingual/palatal side and/or on the vestibular side of the teeth. The layers are formed by a sheet that receives, positions, fits, protects and envelops the dental arch and the accessories, the sheets (plates) being produced from transparent materials such as PET, PET-G, polyurethane, acetate or equivalent materials, wherein each of the sheets (plates) is produced individually using a vacuum forming and/or thermoforming manufacturing process and/or using direct 3D printing manufacturing process, or as a coating applied by spraying or with a brush, or any other available process, according to the orthodontic treatment plan.

Optionally, one of the layers may be produced with a covering to receive the accessories, with the covering being either transparent or opaque, and the layers may be formed from a liquid material or paste as a coating applied by spraying or with a brush, or any other available process, or also formed from the same transparent materials using vacuum forming and/or thermoforming manufacturing processes, and/or by direct 3D printing manufacturing process molded according to the dental arch.

Orthodontic Envelope Multiple Alignment is an aligner that uses digital planning technology to combine the biomechanics of different aesthetic materials, archwires, and other accessories to obtain a resultant sum of forces for performing orthodontic treatments with high precision and results, as well as comfort and aesthetics for the patient. The Orthodontic Envelope Multiple Alignment device is a totally new concept in conventional orthodontic aligners, a totally new concept in controlling and applying equal or different resultant forces in planned locations and directions, and a totally new concept in planning, designing, creating, constructing, and manufacturing an Orthodontic Envelope Multiple Alignment device.

The proposed Orthodontic Envelope Multiple Alignment device uses at least two layers, one of which is a single sheet with or without a covering to envelop, group, insert, cover, protect, enclose, apply, package, position, compress, fit, combine and/or glue to them and/or between them an archwire and/or two or more archwires and/or brackets and/or buccal tubes and/or other various accessories when necessary and/or other apparatus and devices indicated for orthodontic treatment.

By combining these accessories and materials, a sum of resultant forces derived from these materials and accessories is obtained to exert planned, precise, controlled, localized, and directed forces, as well as more assertive and predictable forces to move the teeth during orthodontic treatment, providing much more comfort and aesthetics for the patient during treatment.

The sheets that form the layers may have the same or different hardness and thicknesses in order to have different strengths in certain locations to accurately perform the individual movements of the teeth, mainly, but not limited to, the planned locations and directions using thinner and/or lower hardness and/or flexible material in the interproximal regions between the dental crowns in the aligner and/or medium and/or high hardness material with greater rigidity or as needed on the lingual, vestibular, and occlusal surfaces of the dental crowns.

The Multi-Aligner Orthodontic Envelope device has characteristics, functions, and capabilities to provide high precision in the location and direction of the applied forces to obtain a much more precise orthodontic treatment with significantly more assertive, predictable, and desired results, as well as much more comfort and aesthetics for the patient during orthodontic treatment performed by dental professionals.

### STATE OF THE ART

Existing conventional aligners use only one sheet (plate) and do not incorporate, position, fit and/or glue, do not combine and, especially, do not envelop the sheet (plate) together with the archwire and/or archwires and/or brackets and/or buccal tubes and/or other various accessories when necessary and/or other apparatus and devices indicated for orthodontic treatment located on the lingual/palatal side and/or on the vestibular side of the teeth used for orthodontic treatments.

Since traditional aligners are constructed and manufactured with only one sheet (plate) of thin, flexible materials so as not to cause pain when inserted into the patient's mouth, they deform very easily as a whole and also deform in the shape of the dental arch, i.e., in the individual dental crowns, they are subjected to disordered forces when inserted into the patient's mouth and do not work individually in a satisfactory manner on each dental crown as planned, programmed, and created in the construction and manufacture of the aligner. Due to the deformation suffered and applied to the teeth, these disordered and uncontrolled forces, i.e., forces greater than those planned and predictable or forces less than those planned and predictable, are exerted in directions different from the planned forces, not reaching the teeth planned to receive the desired forces to obtain a good result in the treatment of the patient.

With disordered forces and undesirable locations and directions, tooth movements are not as precise as planned in orthodontic treatment to achieve a satisfactory result.

### OBJECTIVES OF THE INVENTION

Thus, the Multi-Aligner Orthodontic Envelope device, which is the subject matter of this invention, aims to provide a layered device that involves different accessories when necessary and/or other apparatus and devices indicated for orthodontic treatment located on the lingual/palatal side and/or on the vestibular side of the teeth, such as: archwire or archwires and/or brackets and/or buccal tubes and/or other accessories, making it capable of controlling and applying equal or different resultant forces in planned locations and directions.

another subject matter of this invention is to allow, according to the combination of the layers and different accessories, the orthodontic treatment with different degrees of complexity, where the proposed Orthodontic Envelope Multiple Alignment device uses at least two layers, one of which is a single sheet with or without a covering to envelop, group, insert, cover, protect, enclose, apply, package, position, compress, fit, combine and/or glue to them and/or between them an archwire and/or two or more archwires and/or brackets and/or buccal tubes and/or other various accessories when necessary and/or other apparatus and devices indicated for orthodontic treatment.

By combining these accessories and materials of the layers, it is possible to obtain a sum of resultant forces to exert planned, precise, controlled, localized, and directed forces to move the teeth during orthodontic treatment, providing much more comfort and aesthetics for the patient during treatment.

### BRIEF DESCRIPTION OF THE INVENTION

The Orthodontic Envelope Multiple Alignment device consists of a dental arch (A) forming a single body in layers between which are enclosed different accessories (AC) such as: archwire or archwires and/or brackets and/or buccal tubes and/or other various accessories when necessary and/or other apparatus and devices indicated for orthodontic treatment located on the lingual/palatal side and/or on the vestibular side of the teeth. The layers are formed by sheets (plates) produced from transparent materials such as PET, PET-G, polyurethane, acetate or equivalent materials, wherein each of the sheets (plates) is produced individually using a vacuum forming and/or thermoforming manufacturing process and/or using direct 3D printing manufacturing process, or formed by liquid materials or paste as a coating applied by spraying or with a brush, or any other available process, according to the orthodontic treatment plan.

The Orthodontic Envelope Multiple Alignment device can be better understood through the figures that schematically represent:

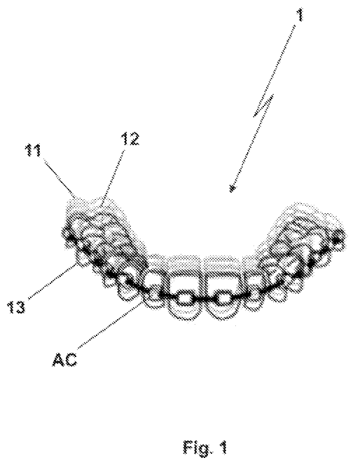

FIG. 1—schematic perspective view of the Orthodontic Envelope Multiple Alignment device;

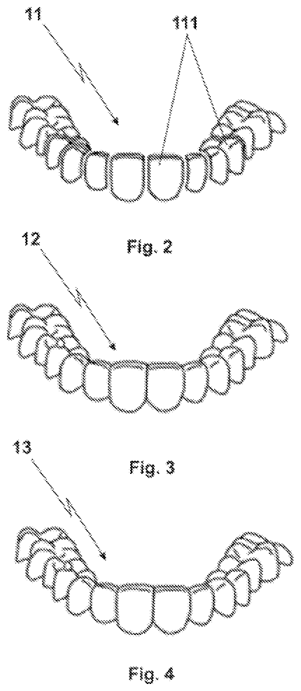

FIG. 2—schematic perspective view of the first layer of the Orthodontic Envelope Multiple Alignment device;

FIG. 3—schematic perspective view of the second layer of the Orthodontic Envelope Multiple Alignment device;

FIG. 4—schematic perspective view of the third layer of the Orthodontic Envelope Multiple Alignment device;

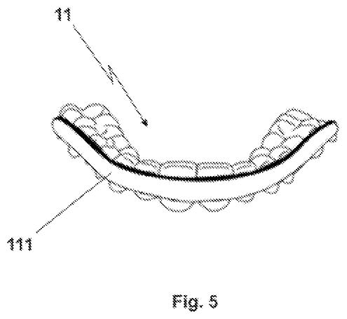

FIG. 5—schematic perspective view of option of the first layer with covering;

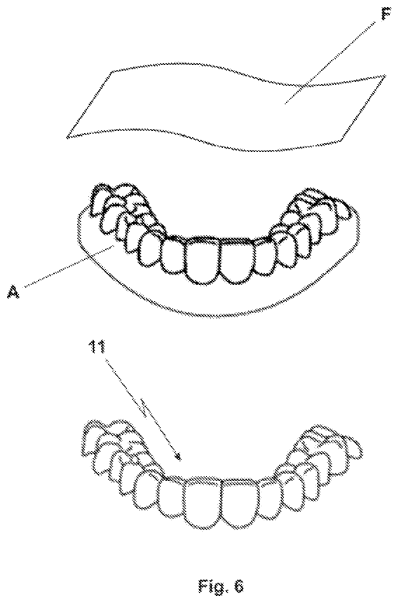

FIG. 6—schematic perspective view of the formation of one of the layers with sheet material;

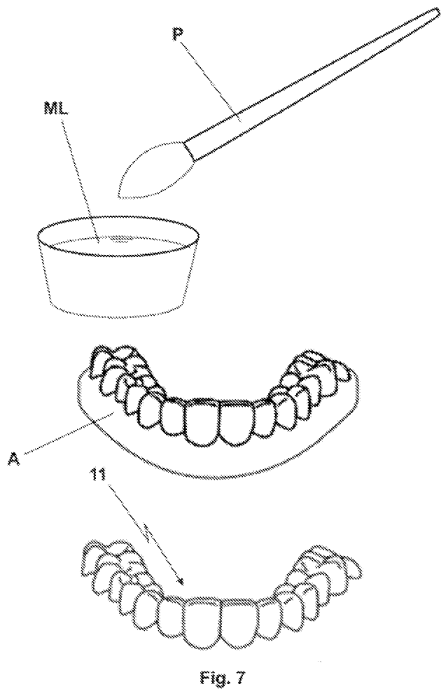

FIG. 7—schematic perspective view of the formation of one of the layers with liquid material or paste;

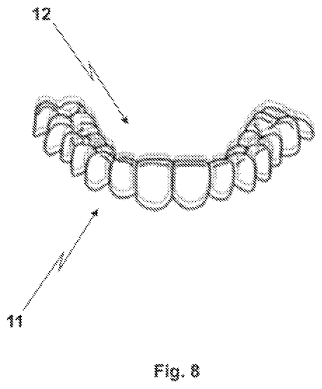

FIG. 8—perspective view of two overlapping layers;

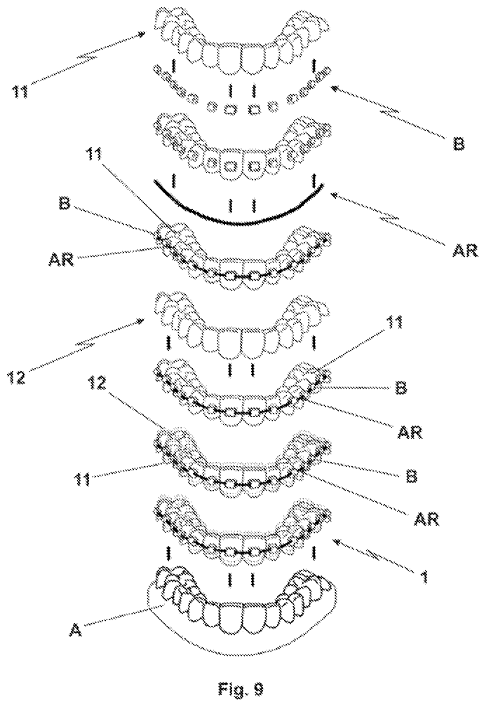

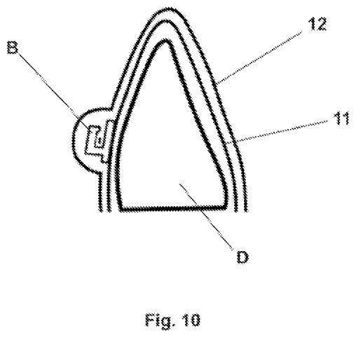

FIG. 9—exploded schematic perspective view of an example of the formation of the device with two layers;

FIG. 10—schematic drawing of the layers of the device on a tooth;

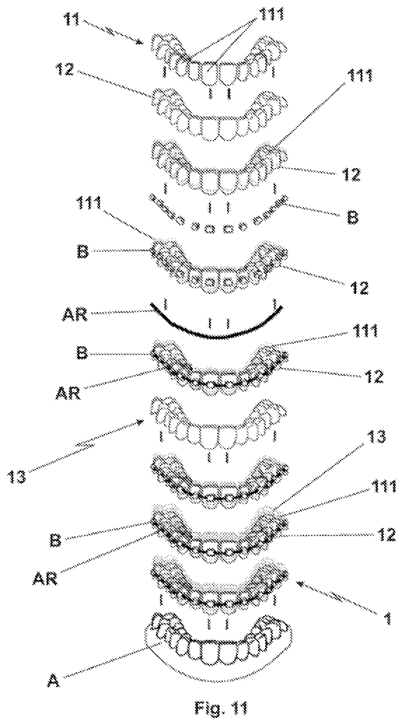

FIG. 11—exploded schematic perspective view of an example of the formation of the device with three layers;

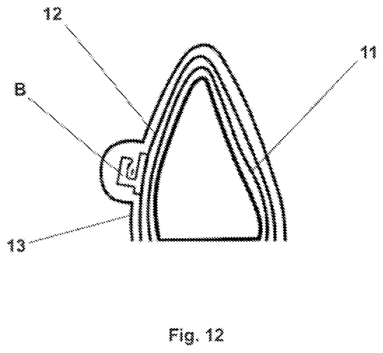

FIG. 12—schematic drawing of the layers of the device on a tooth;

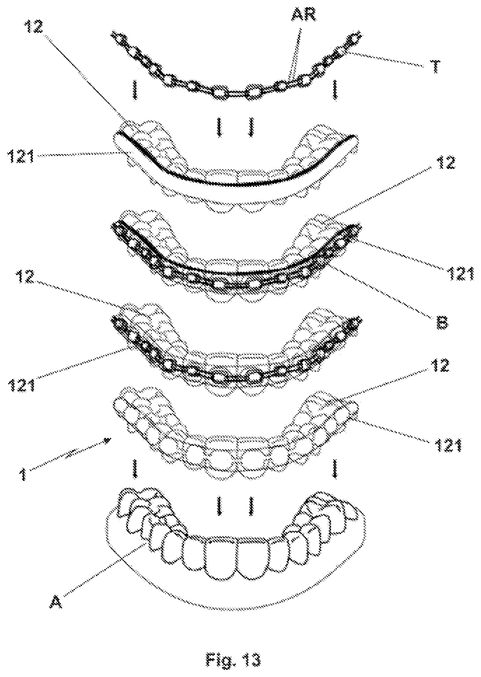

FIG. 13—exploded schematic perspective view of an example of the formation of the device with one layer with covering;

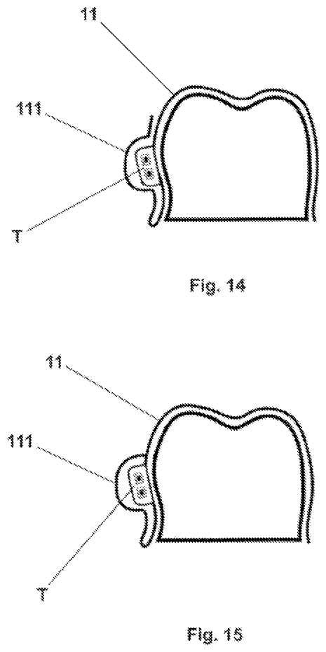

FIG. 14—schematic drawing of the layer with open covering; and

FIG. 15—schematic drawing of the layer with closed covering.

### DETAILED DESCRIPTION OF THE INVENTION

According to the figures presented, the Orthodontic Envelope Multiple Alignment device consists of a dental arch (A) forming a single body (1) with two or three layers (11, 12 and 13), between which are enclosed different accessories (AC) such as: archwire or archwires and/or brackets and/or buccal tubes and/or other various accessories when necessary and/or other apparatus and devices indicated for orthodontic treatment located on the lingual/palatal side and/or on the vestibular side of the teeth.

This layer (11) is formed by individual crowns (111) to receive the accessories (AC), and each of the layers (12 and 13) is formed as a single piece.

The layers are formed by a sheet (F) (see FIG. 6) that receives, positions, fits, protects and envelops the dental arch and the accessories (AC), the sheets (plates) being produced from transparent materials such as PET, PET-G, polyurethane, acetate or equivalent materials, wherein each of the sheets (plates) is produced individually using a vacuum forming and/or thermoforming manufacturing process and/or using direct 3D printing manufacturing process, according to the orthodontic treatment plan. Optionally, the layers (11, 12 and 13) may be produced with liquid material (ML) or paste as a coating applied by spraying or with a brush, or any other available process molded according to the dental arch (A) with the use of a brush (P) (see FIG. 7).

Still optionally, the layer (12) will be provided with a covering (121) to receive the accessories (AC), wherein the covering is either transparent or opaque (see FIGS. 5 and 13).

### EXAMPLES OF EMBODIMENT OF THE INVENTION

According to FIGS. 9 and 10, in a first example of embodiment of the Orthodontic Envelope Multiple Alignment device with two layers, starting from the arch (A), it comprises a single body (1) initially formed by layer (11), which receives Brackets (B) and the archwire (AR), and this assembly receives the second layer (12), thus forming the single body (1) that is positioned over the arch (A) of the patient.

According to FIGS. 11 and 12, in a second example of embodiment of the Orthodontic Envelope Multiple Alignment device with three layers, starting from the arch (A), it comprises a single body (1) initially formed by layer (12) that is overlapped by layer (11) (see FIG. 5), and this first assembly receives the Brackets (B) and the archwire (AR), and this second assembly receives the third layer (13), thus forming the single body (1) that is positioned over the arch (A) of the patient.

According to FIGS. 13, 14 and 15, in a third example of embodiment of the Orthodontic Envelope Multiple Alignment device with one layer provided with a covering, starting from the arch (A), it comprises a single body (1) initially formed by layer (11) with the transparent or opaque covering (111), this being initially open (see FIG. 14) to receive the Tubes (T) with archwires (AR) and later closed (see FIG. 15), thus forming the single body (1) that is positioned over the arch (A) of the patient.

### ADVANTAGES OF THE INVENTION

The Orthodontic Envelope Multiple Alignment device was planned, designed, created, constructed, and manufactured with a totally new manufacturing concept, a totally new concept of using materials and accessories combined to obtain a sum of resultant forces so that these forces have the functions of moving the patient's teeth with precision, with control of location and direction, organized and ordered forces to make movements very similar to the planned and programmed movements to perform orthodontic treatments with significantly more assertive results, much more predictable as planned, as required by dental professionals and orthodontists to perform their treatments satisfactorily.

With a totally new concept of planning, designing, creating, constructing, and manufacturing the Orthodontic Envelope Multiple Alignment device using materials and accessories combined to obtain a sum of resultant forces, this Orthodontic Envelope Multiple Alignment device moves the patient's teeth with great precision in terms of location and direction with controlled forces that no other aligner is capable of achieving. The Orthodontic Envelope Multiple Alignment device offers much more precise, assertive, and predictable treatments, thus providing a great benefit in performing very satisfactory treatments in a much shorter time and using fewer aligners throughout the treatment.

The scope of this patent should not be limited to its application through the examples presented, but rather to the terms defined in the claims and their equivalents.

1-8. (canceled)

9. An orthodontic envelope multiple alignment device comprising:
a dental arch defining a single body having first, second, and third layers made by one of vacuum forming, thermoforming, or 3D printing; and
a plurality of orthodontic treatment accessories disposed between pairs of the first, second, and third layers and configured to be located on the lingual, palatal or vestibular sides of teeth;
wherein:
two of the first, second of third layers are each made of a single piece of material and the other of first, second, or third layers is formed by individual crowns configured to receive the orthodontic treatment accessories, the first, second and third layers are either 3D-printed or made from a liquid material molded with the use of a brush or spray, and the orthodontic treatment accessories include one or more of an archwire, a plurality of archwires, a plurality of brackets, or a plurality of buccal tubes.

10. The orthodontic envelope multiple alignment device of claim 9, further comprising an opaque or transparent covering disposed over one of the first, second, or third layers and configured to receive the orthodontic treatment accessories.
